(19) United States
(12) Patent Application Publication
(10) Pub. No.: US 2018/0057723 A1
(43) Pub. Date: Mar. 1, 2018

(54) BLENDED REFRIGERANT FOR USE IN STATIONARY AND/OR MOBILE AIR CONDITIONING SYSTEMS CONTAINING R-134a, R-152a, R-744 AND R-1234yf

(71) Applicant: FORD GLOBAL TECHNOLOGIES, LLC, Dearborn, MI (US)

(72) Inventors: Edward Stanley Sakowicz, Dearborn Heights, MI (US); Angelo Patti, Pleasant Ridge, MI (US)

(21) Appl. No.: 15/246,066

(22) Filed: Aug. 24, 2016

(51) Int. Cl. C09K 5/04; C10M 107/34; C10M 107/24; C10M 105/38; C10M 171/00; F25B 31/00

(52) U.S. Cl. CPC C09K 5/045; C10M 107/34; C10M 107/24; C10M 105/38; C10M 171/008; F25B 31/002; F25B 2400/121; C09K 2205/122; C09K 2205/126; C10M 2207/2835; C10M 2209/043; C10M 2209/1033; C10N 2240/30; C09K 2205/106

(57) ABSTRACT

A refrigerant composition of R-1234yf, R-134a, R-744 and R-152a is described, wherein R-152a and R-134a comprise 16% by weight or less of the overall composition. The refrigerant compositions may be utilized in heat transfer systems as an efficient and environmentally safe refrigerant.

### TECHNICAL FIELD

This document relates generally to a refrigerant composition for heat transfer in cooling systems, such as air-conditioners and heat pumps.

### BACKGROUND

Heat transfer systems utilize evaporation of a liquid refrigerant at low pressure in a first zone to withdraw heat within the zone. The vapor is compressed and moved to a condenser, allowing the refrigerant to recycle and effectively transfer heat to the second zone. Efficacy with selection of a refrigerant lies in how well it can perform within such a system.

Refrigerant compounds for commercial use must also satisfy consumer safety concerns, such as low flammability. Further, increasing environmental concerns limit the selection of refrigerant compounds based on their ozone depletion potential and greenhouse warming potential. The present invention discussed herein provides for a composition of mixed refrigerants that collectively satisfy these concerns by being highly efficacious, safe and mindful of the environment.

### SUMMARY

In accordance with the purposes and benefits described herein, a less flammable refrigerant blend is provided. That refrigerant blend incorporates a single or blended lubricating oil compatible with various technologies of compressor pumps used in gasoline, diesel, hybrid or electric driven vehicles.

The refrigerant composition of the present invention comprises 0.1-9% R-134a, 0.1-6% R-152a, 0.1-15% R-744 and 0.1-70% R-1234yf. In some embodiments the refrigerant composition comprises 15% by weight or less of R-152a and R-134a, with the remaining 85% comprised of R-744 and R-1234yf. In some embodiments, the refrigerant composition consists essentially of at least 16% by weight of R-134a and R-152a and 84% of R-744 and R-1234yf.

In other aspects, the refrigerant and a lubricant may comprise a composition for an air conditioning unit. The lubricant may be selected from the group consisting of poly alkylene glycol, poly vinyl ether and polyol ester oil. Such compositions may be utilized in a heat transfer device

The present invention further provides methods for cooling a space by operating a heat transfer device within the space, wherein the heat transfer device utilizes the refrigerant of the present invention to transfer heat from the space.

### DETAILED DESCRIPTION

Refrigerant identification has largely focused on identifying single compounds. The present invention has identified a refrigerant composition that blends refrigerant compounds, such that the final product balances the need for efficient cooling with consumer safety and environmental impact. The present invention provides a refrigerant composition comprised of a mixture of refrigerant compounds, such that the resulting mixture provides an efficient, low flammability refrigerant with a low GWP. The present invention provides a composition of 1,1,1,2-tetrafluoroethane (refrigerant R-134a), 1,1, difluoroethane (R-152a), carbon dioxide (R-744) and 2,3,3,3 tetrafluoropropene (R-1234yf). The composition comprises 0.1-9% R-134a, 0.1-6% R-152a, 0.1-15% R-744 and 0.1-70% R-1234yf.

R-134a has been a largely popular refrigerant, but has a global warming potential (GWP) of 1300, thereby seeking the industry to identify compounds with a less detrimental environmental impact. R-134a further can provide toxic vapor when exposed to high temperatures. However, R-134a remains highly effective at absorbing thermal energy. R-152a is also an effective coolant, but is flammable, thereby limiting its use. By including small amounts of R-134a and R-152a the efficient cooling is provided in combination with the other materials, yet the overall GWP is significantly lower as well as overall flammability. Individually, the other components all have much lower GWP than R-134a: R-152a has a GWP of 120; R-744 has a GWP of 1; and, R-1234yf has a GWP of 4.

The composition comprises less than 10% by weight of R-134a, such as around 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9 and 10.0 weight percent.

The composition further comprises less than 6% by weight of R-152a, such as around 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9 and 6.0 weight percent.

As such, the composition comprises 16% by weight or less of the higher GWP compounds, with the remaining 84% comprised of the more environmentally friendly R-744 and R-1234yf. In addition to environmental concerns, a refrigerant composition should be safe, particularly with regard to elevated temperatures and flammability given the heat energy involved in in these systems. R-1234yf is somewhat flammable, whereas R-744 is not. It is understood, however, that fluorocarbon combustion chemistry is significantly unpredictable and non-flammable compounds mixed with a flammable fluorocarbon provide unpredictable results (flammability may be determined in accordance with American Society of Heating, Refrigerating and Air-Conditioning Engineers (ASHRAE) standards). In spite of this, the refrigerant mixture, at the proportions of the four compounds described herein, provides improved flame retardant properties without loss to the cooling efficiency. Further, the refrigerant compositions provide a product with a reduced GWP of below 149, thereby demonstrating suitability to meet industry standards.

R-744 and R-11234yf may comprise around 85% of the overall composition. R-744 may comprise around 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, or 15.0 weight percent of the overall composition. R-1234yf accordingly may comprise between 70 and 85 weight percent of the overall composition. R-1234yf may comprise around 70, 70.1, 70.2, 70.3, 70.4, 70.5, 70.6, 70.7, 70.8, 70.9, 71.0, 71.1, 71.2, 71.3, 71.4, 71.5, 71.6, 71.7, 71.8, 71.9, 72.0, 72.1, 72.2, 72.3, 72.4, 72.5, 72.6, 72.7, 72.8, 72.9, 73.0, 73.1, 73.2, 73.3, 73.4, 73.5, 73.6, 73.7, 73.8, 73.9, 74.0, 74.1, 74.2, 74.3, 74.4, 74.5, 74.6, 74.7, 74.8, 74.9, 75.0, 75.1, 75.2, 75.3, 75.4, 75.5, 75.6, 75.7, 75.8, 75.9, 76.0, 76.1, 76.2, 76.3, 76.4, 76.5, 76.6, 76.7, 76.8, 76.9, 77.0, 77.1, 77.2, 77.3, 77.4, 77.5, 77.6, 77.7, 77.8, 77.9, 78.0, 78.1, 78.2, 78.3, 78.4, 78.5, 78.6, 78.7, 78.8, 78.9, 79.0, 79.1, 79.2, 79.3, 79.4, 79.5, 79.6, 79.7, 79.8, 79.9, 80.0, 80.1, 80.2, 80.3, 80.4, 80.5, 80.6, 80.7, 80.8, 80.9, 81.0, 81.1, 81.2, 81.3, 81.4, 81.5, 81.6, 81.7, 81.8, 81.9, 82.0, 82.1, 82.2, 82.3, 82.4, 82.5, 82.6, 82.7, 82.8, 82.9, 83.0, 83.1, 83.2, 83.3, 83.4, 83.5, 83.6, 83.7, 83.8, 83.9, 84.0, 84.1, 84.2, 84.3, 84.4, 84.5, 84.6, 84.7, 84.8, 84.9, or 85.0 weight percent of the overall composition.

Also provided is a composition for use in cooling systems comprised of the refrigerant composition and a lubricant. The lubricant may be selected from poly alkylene glycol (PAG), poly vinyl ether (PVE) and/or polyol ester oil. Lubricant can affect the performance of the refrigerant utilized, particularly with respect to miscibility and solubility of the refrigerant with the lubricant utilized. The lubricant selected may comprise branched or straight chained alkyl groups. The lubricant may further comprise butylated hydroxyl toluene (BHT). The lubricant may further comprise a stabilizer, such as a diene-based compound(s), phosphates, phenol compounds and epoxides, and mixtures thereof.

Also provided is a refrigeration working fluid comprising about 1 to 55 parts by weight of the lubricant and about 99 to 45 parts by weight of the refrigerant composition. The lubricant may be present at 1 to 35 parts by weight. The refrigerant may be present at 99 to 65 parts by weight. The lubricant and the refrigerant should be combined such that they remain miscible at working temperatures for the system utilized. Across the temperature range to be utilized, a cloudy appearance, the formation of floc or precipitate, or separation into two distinct liquid layers indicates that the two are immiscible.

A flame retardant may also be added to the refrigerant working fluid. Such additives are known in the art and include, for example: tri-(2-chloroethyl)-phosphate, (chloropropyl)phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

A heat transfer device, such as a refrigeration device, comprises the refrigerant composition and/or the refrigerant working fluid. Such heat transfer devices are known in the art and include, for example: automobile air conditioning systems, residential and commercial air conditioning systems, residential and commercial refrigerator systems, residential and commercial freezer systems, chiller air conditioning systems, chiller refrigeration systems, and heat pump systems. Preferably, the heat transfer device is a refrigeration device or an air-conditioning system. Heat transfer devices may contain a centrifugal-type compressor.

The refrigerant composition and/or the refrigerant working fluid may further be provided as blowing agent or as a foamable composition (i.e.capable of forming foam) along with known foaming agents, such as polyurethanes, polystyrene, epoxy resins or other thermoplastic polymers and resins. The compositions of the invention may be provided as a sprayable composition and combined with a propellant.

In accordance with yet another aspect, methods are provided for cooling an object or a space comprising evaporating the refrigerant composition in the space to be cooled or in the vicinity of the object to be cooled and then condensing the refrigerant composition in a space distal to the object or space.

The compositions may be utilized in heat transfer systems that utilize a different refrigerant. Such methods for retrofitting comprise removing an existing heat transfer fluid and introducing the compositions described herein.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled. All patent and non-patent literature cited herein is incorporated by reference in their entirety.

1. A refrigerant composition comprising R-134a, R-152a, R-1234yf and R-744, wherein R-134a and R-152a account for 16% or less by weight of the composition.

2. The refrigerant composition of claim 1, wherein R-134a comprises 10% or less of the composition.

3. The refrigerant composition of claim 1, wherein R-152a comprises 6% or less of the composition.

4. The refrigerant composition of claim 1, wherein R-744 comprises 15% or less by weight of the composition.

5. The refrigerant composition of claim 1, wherein the composition consists essentially of R-152a, R-744, R-134a and R-1234yf.

6. The refrigerant composition of claim 1, wherein R-152a and R-134a comprise 15% or less of the composition.

7. The refrigerant composition of claim 6, wherein R-1234yf and R-744 comprise 85% or more of the composition.

8. The composition of claim 7, wherein R-1234yf comprises at least 51% of the composition.

9. The composition of claim 7, wherein R-1234yf comprises 70% of the composition.

10. A refrigerant working fluid comprising the refrigerant composition of claim 1 and a lubricant.

11. The refrigerant working fluid of claim 10, wherein the lubricant is selected from the group consisting of poly alkylene glycol (PAG), poly vinyl ether (PVE) and polyol ester oil (POE).

12. A heat transfer device comprising the composition of claim 11.

13. A method for cooling a space comprising operating a heat transfer device within the space, wherein the heat transfer device utilizes the composition of claim 11 to transfer heat from the space.
